(19) United States
(12) Patent Application Publication
(10) Pub. No.: US 2021/0138604 A1
(43) Pub. Date: May 13, 2021

(54) TOOL FOR SHAPING ABRADABLE LINERS OF GAS TURBINE ENGINES

(71) Applicant: PRATT & WHITNEY CANADA CORP., Longueuil (CA)

(72) Inventors: Hugo BINETTE, Inverary (CA); Sébastien DUMONT, Cowansville (CA); Lauraleigh NONIS, Toronto (CA); Ehsan FARVARDIN, Longueuil (CA); Bernadette MASON, Milton (CA)

(21) Appl. No.: 16/676,801

(22) Filed: Nov. 7, 2019

(51) Int. Cl. B24B 23/08; B23C 3/02; F01D 11/12; B23B 3/26

(52) U.S. Cl. CPC B24B 23/08; B23C 3/02; B23Q 11/0046; B23B 3/26; F01D 11/122

(57) ABSTRACT

A tool for shaping an abradable liner of a turbofan engine is disclosed. The turbofan engine includes a shaft to support a fan rotatable about a rotation axis. The abradable liner is configured to surround the fan and has an axial length in the direction of the rotation axis. The tool includes a support configured to be mounted to the shaft and rotatable about the rotation axis. The shaping head is mounted to the support for rotation about the rotation axis and configured to shape the abradable liner by removing material from the abradable liner. A radial position of the shaping head is adjustable relative to the rotation axis. The shaping head may sized to extend substantially across the axial length of the abradable liner.

### TECHNICAL FIELD

The disclosure relates generally to gas turbine engines, and more particularly to repairing abradable liners of gas turbine engines.

### BACKGROUND

Turbofan engines include a shaft rotatably supporting a fan within a fan case. A relatively small clearance is desirable between fan blade tips and the fan case. However, thermal or inertial expansion may cause the physical clearance between fan blade tips and the fan case to change. In some situations, fan cases may be provided with an abradable liner on an interior surface of the fan case for safely allowing the fan blade tips to rub against the interior surface of the fan case in some situations.

It is possible, in some environmental (e.g., icy) conditions or due to foreign object ingestion, that the abradable liner could sustain physical damage. Such physical damage may affect performance or be cosmetically undesirable.

### SUMMARY

In one aspect, the disclosure describes a tool for shaping an abradable liner configured to surround a bladed rotor rotatable about a rotation axis in a gas turbine engine. The gas turbine engine includes a shaft configured to support the bladed rotor and the abradable liner has an axial length in the direction of the rotation axis. The tool comprises:

a support configured to be mounted to the shaft; and

a shaping head mounted to the support for rotation about the rotation axis and configured to shape the abradable liner by removing material from the abradable liner, a radial position of the shaping head relative to the rotation axis being adjustable when the support is mounted to the shaft, the shaping head sized to extend substantially across the axial length of the abradable liner.

In another aspect, the disclosure describes an assembly comprising:

a shaft of a turbofan engine configured to support a fan rotatable about a rotation axis;

an abradable liner configured to surround the fan during use, the abradable liner having an axial length in the direction of the rotation axis; and

a tool including:

a support mounted to the shaft and rotatable about the rotation axis; and

a shaping head mounted to the support for rotation about the rotation axis and configured to shape the abradable liner by removing material from the abradable liner, a radial position of the shaping head being adjustable relative to the rotation axis, the shaping head extending substantially across the axial length of the abradable liner.

In a further aspect, the disclosure describes a method of shaping an abradable liner configured to surround a bladed rotor rotatable about a rotation axis in a gas turbine engine, the gas turbine engine including a shaft configured to support the bladed rotor, the abradable liner having an axial length in the direction of the rotation axis, the method comprising:

mounting a tool including a shaping head to the shaft so that the shaping head contacts the abradable liner and extends substantially across the axial length of the abradable liner; and

rotating the shaping head about the rotation axis to shape the abradable liner.

Further details of these and other aspects of the subject matter of this application will be apparent from the detailed description included below and the drawings.

### DESCRIPTION OF THE DRAWINGS

Reference is now made to the accompanying drawings, in which:

FIG. 1 illustrates a schematic axial cross-sectional view of a turbofan gas turbine engine;

FIG. 2 illustrates a perspective view of a tool for shaping an abradable liner of a gas turbine engine;

FIG. 3 illustrates a cross-sectional, elevation view of the tool of FIG. 2 being mounted to a shaft of the gas turbine engine;

FIG. 4 illustrates a perspective view of a shaping head of the tool of FIG. 2 in engagement with the abradable liner of the gas turbine engine;

FIG. 5 illustrates an enlarged cross-sectional, elevation view of the shaping head;

FIGS. 6A and 6B respectively illustrate a side elevation view and a front elevation view of part of the shaping head;

FIGS. 7A and 7B respectively illustrate a perspective view and a side elevation view of a vacuum port attachment of the shaping head;

FIG. 8 illustrates an enlarged cross-sectional, elevation view of an end of the support of the tool of FIG. 2;

FIG. 9 illustrates a flowchart of a method of operating a tool for shaping an abradable liner of a gas turbine engine;

FIG. 10 illustrates a flowchart of another method of operating a tool for shaping an abradable liner of a gas turbine engine;

FIG. 11 illustrates a front view of a gas turbine engine having the tool of FIG. 2 mounted thereto;

FIG. 12A illustrates a perspective view of an abradable applicator tool; and

FIG. 12B illustrates an operator operating the abradable applicator tool of FIG. 12A.

### DETAILED DESCRIPTION

During on-wing engine operation of a (e.g., turbofan) gas turbine engine through icy or harsh environmental conditions, abradable material on a fan case interior may experience physical damage. Damage to the abradable material may affect performance and/or be cosmetically unacceptable. The shaping tool described herein may be operated to shape and repair the abradable material on the fan case interior while the engine remains mounted to the aircraft (e.g., on-wing) without requiring a laborious task of unmounting the gas turbine engine from an aircraft.

The shaping tool described herein includes a sanding head having a contoured profile complementary to a desired fan case gas path profile. As a shaping head of the shaping tool described herein is sized to extend across an axial length of the abradable liner of the fan case interior, the abradable liner may be repaired/profiled/sanded to provide a desired gas path profile by circumferential rotation of the shaping tool about the engine shaft.

Further, as the shaping head is sized to extend across the axial length of the abradable liner of the fan case interior, it may be unnecessary to iteratively circumferentially rotate the shaping tool while adjusting the axial position of the tool along the engine shaft for repairing/profiling/sanding the abradable material. By eliminating multiple axial position adjustments, multiple radial adjustments of the tool to accommodate an axially-varying radial dimension of the abradable liner may also be avoided. Reducing the number of required positional adjustments of the tool may improve the accuracy of the resulting abradable liner.

Although terms such as “maximize”, “minimize” and “optimize” may be used in the present disclosure, it should be understood that such term may be used to refer to improvements, tuning and refinements which may not be strictly limited to maximal, minimal or optimal.

The term “connected” or “coupled to” may include both direct coupling (in which two elements that are coupled to each other contact each other) and indirect coupling (in which at least one additional element is located between the two elements).

The term “substantially” as used herein may be applied to modify any quantitative representation which could permissibly vary without resulting in a change in the basic function to which it is related.

Aspects of various embodiments are described through reference to the drawings.

Reference is made to FIG. 1, which schematically illustrates an axial cross-section of a gas turbine engine 10, in accordance with an embodiment of the present disclosure. The gas turbine engine 10 may be of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. In some embodiments, the gas turbine engine 10 may be a turbofan engine.

The gas turbine engine 10 may include a shaft 20. The shaft 20 may be configured to support a fan 12 rotatable about a rotation axis 24. In some embodiments, the shaft 20 may be coupled to other components of the gas turbine engine 10, such as the turbine section 18 or the like. The shaft 20 may be a “low-pressure” shaft of the gas turbine engine 10.

The fan 12 may be coupled to an end of the shaft 20 for common rotation with the shaft 20. In some examples, when the fan 12 rotates, the fan 12 may draw ambient air to the multistage compressor 14 for pressurizing the air, as described above and into a bypass duct of the gas turbine engine 10. The fan 12 may include one or more fan blades and is considered an example of a bladed rotor referenced herein.

In some embodiments, the fan 12 may be de-coupled or removed from the shaft 20 to allow maintenance personnel to conduct maintenance or repair to the gas turbine engine 10.

The gas turbine engine 10 may include a fan case 22 for housing the fan 12. When the fan 12 is rotationally coupled to the shaft 20, thermal or inertial expansion of the fan blades may cause the physical clearance between fan blade tips and the fan case to change. In some embodiments, the fan case 22 may include an abradable liner (e.g., see liner 312 in FIG. 3) on an interior surface of the fan case 22 to safely allow fan blade tips of the fan 12 to rub against the interior surface of the fan case 22 if necessary. The abradable liner can include an abradable compound that may be applied or spread along at least a portion of the interior surface of the fan case and, subsequently, shaped to a desired profile. In various embodiments, the abradable compound may be a product available under the trade name 3M™ named “Scotch-Weld™ Structural Void Filling Compound”, otherwise known as “Blue Ice” abradable (3M™ Product Number EC-3524). Other types or examples of abradable liners may be contemplated. In some embodiments, the abradable liner on the fan case interior may be shaped/contoured to define part of a gas path guiding the ambient air received into the gas turbine engine 10.

In some embodiments, the abradable liner may be provided on a subset portion of the interior surface of the fan case 22. For example, the abradable liner may extend circumferentially about the fan case interior and may have an abradable axial length along (in the direction of) the rotation axis 24. The abradable axial length may be less than an axial length of fan case 22. For example, the abradable liner may be provided on and proximal to an area of the fan case interior that is adjacent to the fan blade tips and in a circumferential direction.

The gas turbine engine 10 may be subjected to certification testing which may include tests for validating the operation of the gas turbine engine 10 in icy conditions. In some other scenarios, the gas turbine engine 10 may already be commercially operated in the field and in icy environment conditions. During operation of the gas turbine engine 10 in icy environmental conditions, the gas turbine engine 10 may sustain physical damage to the abradable liner on the interior surface of the fan case 22 of the gas turbine engine 10. For example, the fan case 22 may sustain scratches or removal of portions of abradable liner from the interior surface of the fan case 22. The damage may occur along the fan case interior surface in the circumferential direction. In some other scenarios, the abradable liner of the gas turbine engine 10 may sustain damage due to foreign object ingestion.

FIG. 2 is a perspective view of a tool 200 for shaping an abradable liner of the gas turbine engine 10. The tool 200 may be used by maintenance personnel to remedy or repair the physical damage to the abradable liner. The tool 200 may be configurable for on-wing repair of abradable liners for fan cases of gas turbine engines so as to minimize aircraft on ground (AOG) time attributed to repairs, minimize lead time requirements for sourcing and replacing fan cases for gas turbine engines, and/or reduce requirement for gas turbine engine swaps.

The tool 200 may be coupled to a shaft (not illustrated in FIG. 2) and may be operated for shaping an abradable liner (not illustrated in FIG. 2). The abradable liner may surround a bladed rotor such as the fan 12 in the gas turbine engine 10. The shaft may be configured to support the bladed rotor, and the bladed rotor may be rotatable about a rotation axis 290. The abradable liner may be on a fan case interior and may have an axial length along the rotation axis 290.

The tool 200 may include a support 210. The support 210 may be configured to be mounted to the shaft. In some embodiments, the support 210 may have a first end 220 configured to mount to the shaft and a second end 230. In some embodiments, the support 210 may be an adjustable length support. For example, the support 210 may be adjustable in a radial direction 292. The radial direction 292 may be substantially normal or perpendicular to the rotation axis 290. For example, when the tool 200 is coupled to the shaft, the support 210 may be adjusted to extend in the radial direction 292.

The tool 200 may include a shaping head 240 mounted to the support 210. The shaping head 240 may be mounted to the second end 230 of the support 210. A radial position of the shaping head 240 relative to the rotation axis 290 may be adjustable when the support 210 is mounted to the shaft.

In some embodiments, the shaping head 240 may be configured to include a sanding surface having a profile complementary to a final profile of the abradable liner. In some embodiments, the sanding surface may be a contoured profile complementary to a desired gas path that is characteristic of the gas turbine engine 10. As will be described, when the tool 200 is mounted to the shaft and rotated circumferentially about the shaft, the shaping head 240 may shape the abradable liner on the fan case interior of the gas turbine engine 10. The shaped abradable liner may direct gas (air) along a defined gas path of the gas turbine engine 10.

The shaping head 240 may be sized to extend across the axial length of the abradable liner for shaping the abradable liner. For example, the shaping head 240 may have an axial dimension 242 substantially corresponding to the axial length of the abradable liner. As will be described and illustrated, the axial length may extend from a proximal edge to a distal edge of the abradable liner.

In some embodiments, the sanding head 240 may include a vacuum port attachment 244 configured to couple to a suction device such as a vacuum cleaner known as a “shop-vac” for example. The vacuum port attachment 244 may be a conduit for collecting abradable material removed from the abradable liner while the sanding head 240 contacts and is moved across the abradable liner surface.

In some embodiments, the support 210 may include a threaded adapter 250 for coupling the tool 200 to the shaft when the bladed rotor is removed from the shaft. For example, the threaded adapter 250 may be configured to mount the first end 220 of the support 210 to a mating threaded end or other mounting surface of the shaft.

As the threaded adapter 250 may be configured to couple the first end 220 to the shaft via a threaded interface, the threaded adapter 250 may be configured to re-position the shaping tool in a direction along the rotation axis 290. For example, the threaded adapter 250 may advance the shaping tool 200 in the rotation axis 290 such that the positioning of the shaping head 240 in a direction along the rotation axis 290 may be offset. By making positional adjustments of the shaping head 240 in the rotation axis 290, maintenance personnel may adjust alignment of the shaping head 240 relative to the abradable liner. In some embodiments, the threaded adapter 250 may include one or more rolling-element (e.g., ball, roller) bearings 252 operatively disposed between the threaded adapter 250 and the support 210.

In some embodiments, the tool 200 may include a counterweight 260 substantially diametrically opposed to the support 210 relative to the rotation axis 290. As illustrated in FIG. 2, the counterweight 260 may be an ergonomic balance bar configured for allowing an operator of the tool to utilize the counterweight 260 as a handle for rotating the tool 200 about the shaft. Further, the counterweight 260 may be configured to counterbalance the tool 200 to promote ease of use. The counterweight 260 may be used by an additional (e.g., second) operator of the tool 200 to assist a primary operator of the tool 200 to operate the tool 200.

FIG. 3 is a cross-sectional, elevation view of the tool 200 of FIG. 2 mounted to a shaft 320 of a gas turbine engine 300. The example gas turbine engine 300 includes a fan case 310 and an engine shaft 320 extending along a rotation axis 390. The engine shaft 320 may be configured to rotatably support a fan within the fan case 310. In FIG. 3, the fan is not illustrated. In some embodiments, the fan may be removed prior to mounting the tool 200 to the engine shaft 320.

The fan case 310 may have an abradable liner 312 on a surface of the fan case interior. The abradable liner 312 may have an axial length 314 along the rotation axis 390. Further, the abradable liner 312 may extend circumferentially (i.e., a full 360°) about the fan case interior. Once the abradable liner 312 is shaped after operation of the tool 200, the abradable liner 312 may have a profile defining a gas path.

The tool 200 may be mounted to the engine shaft 320 via the support 210. In some embodiments, the support 210 may be a telescopic shaft configurable for adjusting the positioning of the shaping head 240 relative to the abradable liner 312 in a radial direction of the fan case 310. By adjusting the telescopic shaft in the radial direction, the tool 200 may be configured to circumferentially shape the abradable liner 312 for providing a desired fan case opening diameter and also providing a desired profile of the abradable liner.

As illustrated in FIG. 3, the shaping head 240 may be mounted to the support 210 and may be sized to extend across the axial length 314 of the abradable liner 312 for shaping the abradable liner when the tool 200 is circumferentially rotated about the axis 390.

In the illustrated example, upon at least one circumferential rotation of the tool 200 about the engine shaft 320, the tool 200 may shape the abradable liner 312. As the shaping head 240 is sized to have an axial dimension 242 (FIG. 2) substantially corresponding to the axial length 314 of the abradable liner 312, it may be unnecessary to adjust the position of the shaping tool 200 along the rotation axis 390 for shaping the abradable liner 312.

In FIG. 3, as the shaping head 240 may be sized to have an axial dimension 242 (see FIG. 2) substantially corresponding to the axial length 314 of the abradable liner 312, operations for shaping the abradable liner 312 need not rely on manual, and/or iterative adjustments of the tool 200 in the axial direction 390 for shaping the abradable liner 312 from a proximal edge 316 to a distal edge 318 and circumferentially around the fan case interior.

In some embodiments, the shaping head 240 or part(s) thereof may be cast or produced using three-dimensional (3D) printing apparatus. The shaping head 240 may include a sanding surface having a profile complementary to a desired profile on the abradable liner 312.

In some embodiments, the support 210 may include a radial adjustment knob 280 for adjusting the length of the adjustable length support 210. Adjusting the length of the adjustable length support 210 may position the shaping head 240 nearer or away from the abradable liner. Accordingly, maintenance personnel may position the tool 200 and adjust the radial position of the shaping head 240 accordingly to provide a defined fan case diameter.

FIG. 4 illustrates a perspective view of the sanding head 240 of the tool 200 for shaping an abradable liner 312 of the gas turbine engine. In FIG. 4, the abradable liner 312 may be on a portion of an interior of the fan case 310. The abradable liner 312 may be provided on subset portions of the fan case interior adjacent to the fan blade tips and in a circumferential direction 498. That is, the abradable liner 312 may surround a bladed rotor. In some examples, the abradable liner 312 may extend in the circumferential direction 498 and may have an axial length 314.

As illustrated in FIG. 4, the shaping head 240 includes an axial dimension 242 that substantially corresponds to the axial length 314 of the abradable liner 312. The axial length 314 of the abradable liner 312 may extend from a proximal edge 316 to a distal edge 318 of the abradable liner 312. Upon at least one rotation of the tool 200 in the circumferential direction 498 about the engine shaft (not illustrated in FIG. 4), the tool 200 may shape the abradable liner for directing gas along a defined gas path.

Reference is made to FIG. 5, which illustrates a cross-sectional view of the shaping head 240 (FIG. 2) in combination with the vacuum port attachment 244 (see FIG. 2). In some embodiments, the vacuum port attachment 244 may include a frustoconical shape for receiving a hose of a vacuum or suction device. In some other embodiments, the vacuum port attachment 244 may be configured with other shapes or geometric configurations.

In some embodiments, the support 210 may include a handle 560 proximal to the second end 230, such that maintenance personnel may apply torque for rotating the tool 200 in a circumferential direction about the engine shaft.

In some embodiments, the shaping head 240 may be mounted to the second end 230 of the adjustable length support 210 in a fixed configuration. For example, the shaping head 240 may be mounted to the second end 230 of the adjustable length support 210 such that the shaping head 240 may not be flexed, pivoted, or rotated about the second end 230 when the tool 200 is circumferentially rotated about the engine shaft. In some examples, the shaping head 240 may be affixed to the second end 230 using a screw. Other methods of affixing the shaping head 240 to the second end 230 may be contemplated.

Reference is made to FIG. 6A, which illustrates a side elevation view of a shaping head 640, in accordance with an embodiment of the present disclosure. The shaping head 640 may include a sanding surface 642 having a contoured profile complementary to a desired abradable liner shape for defining a gas path on a fan case interior of a gas turbine engine. The sanding surface 642 may be configured to have the axial dimension 242 substantially correspond to the axial length of an abradable liner on a fan case to be shaped. The sanding surface 642 may be abrasive so that contact and relative movement between the sanding surface 642 and the abradable liner will cause material removal from the abradable liner. In some embodiments, suitable sand paper may be applied to the sanding surface 642. Alternatively, the sanding surface 642 may be part of a replaceable/consumable abrasive component that may be removably attached to the remainder of the shaping head 640.

Reference is made to FIG. 6B, which illustrates a front elevation view of the shaping head 640 of FIG. 6A. As illustrated in FIG. 6B, the shaping head 640 may include filleted edges 644. In some examples, the sanding head 640 may include a doubly curved sanding surface. It may be appreciated that the filleted edges 644 may have a greater or lesser radius of curvature for providing the shaping head profile surface. The contoured profile or doubly curved sanding surface described herein are merely illustrative examples, and other sanding surface profiles may be contemplated.

Reference is made to FIG. 7A, which illustrates a perspective view of a vacuum port attachment 744 of the shaping head. In some embodiments, the vacuum port attachment 744 may be a structure that may be detachably coupled to the shaping head 640 illustrated in FIG. 6.

FIG. 7B illustrates a side elevation view of the vacuum port attachment 744 of FIG. 7A. As illustrated in FIG. 7B, the vacuum port attachment 744 may include a contoured shape 742 having a profile corresponding to the contoured profile of the sanding surface 642 of the shaping head 640 illustrated in FIG. 6A.

FIG. 8 illustrates an enlarged cross-sectional view of the first end 220 of the support 210 of FIG. 2. FIG. 8 also illustrates an engine shaft 870 having a mating threaded end 872 at an end of the engine shaft 870. The first end 220 of the support 210 of FIG. 2 may include the threaded adapter 250 and may be configured to mount to the threaded end 872 of the engine shaft 870. Accordingly, the threaded adapter 250 may be configured to couple the first end 220 of the support 210 (FIG. 2) to the mating threaded end 872 of the engine shaft 870.

In some examples, the threaded adapter 250 may be threaded towards or away from the mating threaded end 872 in a direction of the rotation axis such that the tool may be offset in the rotation axis.

The threaded adapter 250 may include one or more rolling-element bearings 252 coupling the threaded adapter 250 to the support. The one or more rolling-element bearings 252 may be ball bearings and may be configured to decrease friction between the threaded adapter 250 and the support 210, thereby enhancing ease of circumferential rotation of the tool about the engine shaft 870.

In some embodiments, the adjustable length support may include a radial adjustment knob 880 configured to adjust the length of the adjustable length support. For example, the radial adjustment knob 880 may be rotated and, via threaded engagement with a telescoping portion of the support 210, to incrementally increase the length of the support 210 for positioning the shaping head nearer to the abradable liner, or incrementally decrease the length of the adjustable length support 210 for positioning the shaping head further away from the abradable liner. Other structures for configuring length adjustment of the support 210 may be suitable.

Reference is made to FIG. 9, which illustrates a flowchart of a method 900 of shaping an abradable liner configured to surround a bladed rotor of a gas turbine engine, in accordance with an embodiment of the present disclosure. In some examples, the gas turbine engine may be a turbofan engine. The gas turbine engine may include a shaft configured to support a bladed rotor such as the fan 12 illustrated in FIG. 1. The bladed rotor may be rotatable about a rotation axis. The abradable liner may have an axial length along the rotation axis. The tool may include a support and a shaping head mounted to the support.

At operation 910, the tool, including the shaping head, is mounted to the shaft so that the shaping head contacts the abradable liner and extends substantially across the (entire) axial length of the abradable liner. The axial length may extend along the rotation axis.

Referring again to FIG. 3 as an illustrative example, the support 210 of the tool 200 may be mounted to the engine shaft 320 via a threaded adapter 250. As illustrated in FIG. 3, the shaping head 240 is sized to extend substantially across the axial length 314 of the abradable liner 312.

At operation 920, the shaping head may be rotated about the rotation axis to shape the abradable liner.

Referring again to FIG. 4 as an illustrative example, the tool may be rotated, such that the shaping head 240 contacts and shapes the abradable liner 312 as the shaping head 240 is rotated circumferentially about the engine shaft. As the shaping head 240 includes a sanding surface having a profile complementary to a desired abradable liner shape for defining a gas path, operations of the method 900 of FIG. 9 may shape the abradable liner 312 for defining a gas path on a fan case interior of a gas turbine engine.

The method 900 or other methods disclosed herein may be used in a repair procedure where abradable material in paste form is (e.g., manually) added to the abradable liner to repair the abradable liner, the added abradable material is allowed to cure and then the desired shape of abradable liner is restored using the tool described herein. In order to remove a desired amount of material (i.e., thickness) from the abradable liner, the shaping head may be iteratively adjusted radially outwardly after one or more revolutions of the shaping head as material is abraded from the abradable liner.

Reference is made to FIG. 10, which illustrates a flowchart of a method 1000 of shaping an abradable liner of a gas turbine engine, in accordance with another embodiment of the present disclosure. The abradable liner may be configured to surround a bladed rotor of the gas turbine engine. Operation 1010 and operation 1020 may substantially correspond to operation 910 and operation 920, respectively, of the method 900 described with reference to FIG. 9.

In addition to the operations of method 900, in some embodiments, prior to rotating the shaping head circumferentially about the engine shaft or about the rotation axis, at operation 1030, the radial position of the shaping head may be adjusted relative to the rotation axis. The adjustments of the radial position of the shaping head may include extending or retracting the support. Maintenance personnel may set up the tool for providing a desired fan case radius once the tool is circumferentially rotated about the engine shaft. The fan case radius may be measured as between the abradable liner and the engine shaft. Accordingly, the tool may be adjusted to circumferentially shape the abradable liner for providing a desired fan case diameter opening.

As described herein, the threaded adapter of the adjustable length support may be threaded to a mating threaded end of the engine shaft. Thus, in some embodiments, at operation 1040, the axial position of the shaping head may be adjusted relative to the abradable liner. For example, the threaded adapter may be adjusted to re-position the shaping tool in a direction of the rotation axis for aligning the sanding surface of the sanding head to substantially extend across the axial length of the abradable liner from a proximal edge to a distal edge of the abradable liner. The threaded adapter may couple the tool to the shaft.

For example, referring again to FIG. 3, maintenance personnel may adjust the threaded adapter 250 for adjusting the offset position of the tool 200 in a direction along the rotation axis 390. Adjustments to the threaded adapter 250 for adjusting a radial position of the shaping head in a direction along the rotation axis 390 may be desirable when the axial dimension 242 of the sanding head 240 may not be initially aligned with the axial length 314 of the abradable liner.

In some embodiments, a vacuum device may be coupled to the tool 200 for collecting loose abradable material/particles loosened during operation of the tool 200. For example, a suction device, via a conduit or hose, may be coupled to a vacuum port attachment 744 of the sanding head. That is, the method may include extracting material removed from the abradable liner by the shaping head via a vacuum port attachment 744 associated with the shaping head. Further, the suction device may be activated (e.g., turned on) for collecting abradable liner particles (e.g., abradable dust) during shaping of the abradable liner while the tool is circumferentially rotated about the engine shaft. That is, the method may include extracting the material removed from the abradable liner while rotating the shaping head.

Reference is made to FIG. 11, which illustrates a front view of a gas turbine engine 1100 having a tool 1120 mounted thereon, in accordance with an embodiment of the present disclosure. The tool 1120 may be similar to the tool 200 described with reference to FIG. 2. The tool 1120 may include a counterweight 1122 substantially diametrically opposed to the support 1124 of the tool 1120 relative to the rotation axis 1190. Further, a vacuum device 1190 may be coupled, via a vacuum hose, to a vacuum port of the tool 1120.

In some embodiments described herein, the tool may be configured or mounted to shape an abradable liner of a gas turbine engine while the engine is on-wing. Accordingly, physical damage to the abradable liner of the fan case interior may be repaired by circumferential rotation of the tool about the engine shaft of a gas turbine engine.

As described, embodiments of the tool described herein may include a combination of parts (e.g., shaping head, support, threaded adapter, etc.) that when assembled may be configured to shape an abradable liner of a gas turbine engine. The combination of parts may be included in a “flyaway kit” that may be stored within a cargo bay of an aircraft. In some embodiments, the flyaway kit may include a further applicator tool for spreading initially applied abradable compound on a fan case interior prior to operating the shaping tool 200 (FIG. 2) to shape the abradable compound. FIG. 12A illustrates an abradable applicator tool 1200, in accordance with an embodiment of the present disclosure.

In some examples, an operator of the shaping tool may initially apply abradable compound on the fan case interior. To avoid having insufficient abradable compound being applied to the fan case interior and subsequently needing to re-apply abradable compound atop partially cured abradable compound, the abradable applicator tool 1200 may be configured to provide guidance to the operator for ensuring that abradable compound having at least a minimum thickness has been applied to the fan case interior prior to shaping the applied abradable compound with embodiments of the shaping tool (e.g., shaping tool 200 of FIG. 2) described herein.

The abradable applicator tool 1200 may include a frame 1202. The frame 1202 may have a length greater than an axial dimension 242 (FIG. 2) of a shaping head of a tool described herein. The frame 1202 may include one or more handles 1204. One or more handles 1204 may be grasped by an operator for operating the abradable applicator tool 1200 for spreading abradable compound on the fan case interior.

The frame 1202 may include a guide 1206. When the abradable applicator tool 1200 is operated, the guide 1206 may be placed adjacent to and slid along an edge of the fan case opening as an operator slides the abradable applicator tool 1200 across the fan case interior. The guide 1206 may provide a reference point for positioning the abradable applicator tool 1200 across the fan case interior as the abradable applicator tool 1200 is slide across the fan case interior.

The abradable applicator tool 1200 may include one or more runners 1208 positioned on an applicator edge 1210. In the example illustrated in FIG. 12, the abradable applicator tool 1200 includes a pair of runners 1208. The respective runners 1208 may be spaced apart along the applicator edge 1210. In some embodiments, the respective runners 1208 may be positioned along the applicator edge 1210 such that when the abradable applicator tool 1200 is slid along the fan case interior, the respective runners 1208 may be positioned along a proximal edge or a distal edge of the desired abradable liner. That is, the respective runners 1208 may be spaced apart by a distance corresponding to or greater than the axial length of the desired abradable liner.

When positioned on the applicator edge 1210, the respective runners 1208 may include a protruding surface 1212 configured to slide on the fan case interior as the abradable applicator tool 1200 is slid along the fan case interior. The protruding surface 1212 of the respective runners 1208 may be offset from the applicator edge 1210 to allow passage of abradable compound between the applicator edge 1210 and the fan case interior. The offset of the applicator edge 1210 from the protruding surface 1212 of the respective runners 1208 may correspond to a defined thickness as the operator slides the frame 1202 across the fan case interior. The offset of the protruding surface 1212 of respective runners 1208 from the applicator edge 1210 may provide a gap thickness having a distance measurement that is greater than a final defined abradable liner thickness on the fan case interior.

In some embodiments, the portion of the applicator edge 1210 between the pair of runners 1208 may have a contour or profile that is generally complementary to a desired abradable liner profile on the fan case interior surface.

The abradable compound may be initially applied to the fan case interior and may have a thickness greater than the offset distance between the protruding surface 1212 of the respective runners 1208 and the applicator edge 1210. The gap between the applicator edge 1210 and the fan case interior may allow passage of a subset volume of the abradable compound that was initially applied to the fan case interior when the operator slides the abradable applicator tool 1200 across the fan case interior.

The thickness of the subset volume of the abradable compound may be greater than a final defined abradable liner thickness on the fan case interior. An operator may subsequently (after curing of the abradable compound) operate embodiments of the shaping tool described herein to shape the subset volume of the abradable compound to the final defined abradable liner thickness and gas path shape on the fan case interior.

In scenarios where the operator may initially apply insufficient volume of abradable compound on the fan case interior, when the operator slides the applicator tool 1200 across the fan case interior, the abradable applicator tool 1200 may not remove abradable compound, thereby providing the operator with a visual indication of insufficient initially applied abradable compound. Accordingly, the applicator tool 1200 may be operated by an operator to provide a visual indication of whether a sufficient volume of abradable compound is applied to the fan case interior, thereby avoiding situations where re-application of abradable compound atop previously applied and partially cured abradable compound may be needed.

FIG. 12B illustrates an operator 1250 grasping the abradable applicator tool 1200 and sliding the abradable applicator tool 1200 across the fan case interior 1210. The abradable applicator tool 1200 may remove an excess portion 1220 of initially applied abradable compound as the operator slides the applicator tool 1200 across the fan case interior. The excess portion 1220 of the initial applied abradable compound may correspond to abradable compound positioned above the gap provided by the offset distance between the protruding surface 1212 of the respective runners 1208 and the applicator edge 1210.

In FIG. 12B, a guide (not explicitly shown) may be slid adjacent to an edge 1220 of the fan case opening to provide a reference point for positioning the abradable applicator tool 1200 across the fan case interior as the abradable applicator tool is slid across the fan case interior.

Further, in FIG. 12B, as the abradable applicator tool 1200 is slid across the fan case interior, the respective runners 1208 may be positioned proximal to the proximal edge 1216 or the distal edge 1218 of the desired abradable liner.

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

What is claimed is:

1. A tool for shaping an abradable liner, the abradable liner, in use, surrounding a bladed rotor rotatable about a rotation axis in a gas turbine engine, the gas turbine engine including a shaft configured to support the bladed rotor, the abradable liner having an axial length in the direction of the rotation axis, the tool comprising:
a support configured to be mounted to the shaft; and
a shaping head mounted to the support for rotation about the rotation axis and configured to shape the abradable liner by removing material from the abradable liner, a radial position of the shaping head relative to the rotation axis being adjustable when the support is mounted to the shaft, the shaping head sized to extend substantially across the axial length of the abradable liner.

2. The tool of claim 1, wherein the shaping head includes a sanding surface having a profile complementary to a final profile of the abradable liner.

3. The tool of claim 1, wherein the shaping head includes a doubly curved sanding surface.

4. The tool of claim 1, wherein the shaping head includes a vacuum port configured to couple to a suction device.

5. The tool of claim 1, comprising a threaded adapter configured to couple the tool to the shaft when the bladed rotor is removed from the shaft.

6. The tool of claim 5, comprising a rolling-element bearing operatively disposed between the threaded adapter and the support.

7. The tool of claim 1, comprising a counterweight substantially diametrically opposed to the support relative to the rotation axis.

8. An assembly comprising:
a shaft of a turbofan engine configured to support a fan rotatable about a rotation axis;
an abradable liner configured to surround the fan during use, the abradable liner having an axial length in the direction of the rotation axis; and
a tool including:
a support mounted to the shaft and rotatable about the rotation axis; and
a shaping head mounted to the support for rotation about the rotation axis and configured to shape the abradable liner by removing material from the abradable liner, a radial position of the shaping head being adjustable relative to the rotation axis, the shaping head extending substantially across the axial length of the abradable liner.

9. The assembly of claim 8, wherein the shaping head includes a sanding surface having a profile complementary to a final profile of the abradable liner.

10. The assembly of claim 8, wherein the shaping head includes a doubly curved sanding surface.

11. The assembly of claim 8, wherein the fan is removed from the shaft and the tool is mounted to the shaft via a threaded adapter.

12. The assembly of claim 11, comprising a rolling-element bearing operatively disposed between the threaded adapter and the support.

13. The assembly of claim 8, comprising a counterweight substantially diametrically opposed to the support relative to the rotation axis.

14. A method of shaping an abradable liner configured to surround a bladed rotor rotatable about a rotation axis in a gas turbine engine, the gas turbine engine including a shaft configured to support the bladed rotor, the abradable liner having an axial length in the direction of the rotation axis, the method comprising:
mounting a tool including a shaping head to the shaft so that the shaping head contacts the abradable liner and extends substantially across the axial length of the abradable liner; and
rotating the shaping head about the rotation axis to shape the abradable liner.

15. The method of claim 14, comprising, prior to rotating the shaping head about the rotation axis, adjusting a radial position of the shaping head relative to the rotation axis.

16. The method of claim 14, comprising, prior to rotating the shaping head about the rotation axis, adjusting an axial position of the shaping head relative to the abradable liner.

17. The method of claim 16, wherein adjusting an axial position of the shaping head includes adjusting a threaded adapter coupling the tool to the shaft.

18. The method of claim 14, comprising extracting material removed from the abradable liner by the shaping head via a port associated with the shaping head.

19. The method of claim 18, comprising extracting the material removed from the abradable liner while rotating the shaping head.

20. The method of claim 14, comprising, prior to mounting the tool to the shaft, removing the bladed rotor from the shaft.
